(19) United States
(12) Patent Application Publication
(10) Pub. No.: US 2009/0024480 A1
(43) Pub. Date: Jan. 22, 2009

(54) Method And System For Publishing Online Advertisement

(75) Inventor: Zhao Dai, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 12/206,416

(22) Filed: Sep. 8, 2008

Related U.S. Application Data
(63) Continuation of application No. PCT/CN2007/001013, filed on Mar. 28, 2007.

(30) Foreign Application Priority Data
Mar. 29, 2006 (CN) 200610067462.0

(51) Int. Cl. G06Q 30/00

(52) U.S. Cl. 705/14

(57) ABSTRACT

The present disclosure discloses a method for publishing an online advertisement, including: downloading a raw advertisement creative file needed for publishing an advertisement; updating an advertisement target file according to the downloaded raw advertisement creative file; and displaying the advertisement according to the updated advertisement target file. The present disclosure further provides a system for publishing an online advertisement, an advertisement processing apparatus and an advertisement service apparatus. The solution enables dynamic advertisement publication in online games. Furthermore, an advertisement index file can be adopted in the solution to contain advertisement management parameters adapted to manage the advertisements displayed in online games, therefore the advertisement publication can be more flexible and the advertisements can be more effective.

### CROSS-REFERENCE TO RELATED APPLICATIONS

This application is a continuation of International Application No. PCT/CN2007/001013, filed on Mar. 28, 2007. This application claims the benefit and priority of Chinese Patent Application No. 200610067462.0, filed Mar. 29, 2006. The entire disclosures of each of the above applications are incorporated herein by reference.

### FIELD

The present disclosure relates to the Internet technology, and particularly, to a method and system for publishing an online advertisement and an advertisement processing apparatus and an advertisement service apparatus.

### BACKGROUND

This section provides background information related to the present disclosure which is not necessarily prior art.

With the widespread use of Internet and the continuous development of information technology, online advertisements on the Internet have been developing much faster than traditional advertisements and have been changing the conventional marketing pattern.

Currently, the online advertisements are published in games mainly by customizing the games. To be specific, raw advertisement creative files are embedded into online games when the online games are developed, and the online games display corresponding advertisements according to the embedded raw advertisement creative files when a user run the online games. For example, in online chess and card games, the game tables, cards or chessmen are used to display advertisements.

According to the above technique to publish an online advertisement, since the raw advertisement creative files needed for publishing an advertisement are embedded into clients of online games, when new advertisements are to be published in the online games, the online games should be re-programmed according to the new advertisements and the user should download the newly re-programmed online games, and thus the new online advertisements can be displayed to the user in the online games. For example, in a game zone customized for a beverage company in an instant messaging system, if the beverage company wants to display ever updating advertisements to users of the online game, the users have to download new versions of the online game again and again.

As can be seen from the above, through the method for publishing online advertisements in online games by embedding raw advertisement creative files into the online games, new advertisements can be published only by releasing new versions of online games, which makes the publication of new advertisements inconvenient.

### SUMMARY

This section provides a general summary of the disclosure, and is not a comprehensive disclosure of its full scope or all of its features.

In view of the above, one aspect provides a method for publishing an online advertisement so as to publish a new advertisement in an online game without updating a program of the online game.

To attain the above aspect, the present disclosure provides a method for publishing an online advertisement, including:

downloading a raw advertisement creative file needed for publishing an advertisement;

updating an advertisement target file according to the raw advertisement creative file; and

displaying the advertisement according to the updated advertisement target file.

Another aspect is to provide a system for publishing an online advertisement that publishes new advertisements to a game client without updating programs of games.

To attain the above aspect, the present disclosure provides a system for publishing an online advertisement, including: an advertisement service apparatus, an advertisement processing apparatus and a game client.

The advertisement service apparatus is adapted to provide a raw advertisement creative file needed for publishing an advertisement; the advertisement processing apparatus is adapted to download the raw advertisement creative file from the advertisement service apparatus and update an advertisement target file in the game client according to the raw advertisement creative file; and the game client is adapted to display the advertisement according to the updated advertisement target file.

Yet another aspect is to provide an advertisement processing apparatus, which enables a game client to display new advertisements without updating a program of a game.

To attain the aspect, the present disclosure provides an advertisement processing apparatus, including: a raw creative file downloading unit and an update management unit.

The raw creative file downloading unit is adapted to download a raw advertisement creative file from an advertisement service apparatus; and the update management unit is adapted to update, according to the raw advertisement creative file downloaded by the raw creative file downloading unit, an advertisement target file in a game client connected to the update management unit.

Yet another aspect is to provide an advertisement service apparatus that publishes new advertisements in a game client without updating the program of the game.

To attain the above aspect, the present disclosure provides an advertisement service apparatus, including: raw creative file storage unit and raw creative file processing unit.

The raw creative file storage unit is adapted to store the raw advertisement creative file needed for publishing advertisements; and the raw creative file processing unit is adapted to extract a raw advertisement creative file from the storage unit and send the raw advertisement creative file to an advertisement processing unit.

According to the method for publishing an online advertisement, the raw advertisement creative file needed for publishing an advertisement is by downloaded from the advertisement service apparatus, the advertisement target file in the game client is updated according to the downloaded raw advertisement creative file, and the advertisement to be published is displayed in the game client according to the updated advertisement target file. Therefore, the objective of publishing a new advertisement can be achieves without updating the version of an online game on the game client. The present disclosure further provides a system for publishing an online advertisement, an advertisement processing apparatus and an advertisement service apparatus. The solution enables dynamic advertisement publication in the online game. Furthermore, an advertisement index file can be adopted in the solution to contain advertisement management parameters adapted to manage the advertisements displayed in online games, therefore the advertisement publication can be more flexible and the advertisements can be more effective.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The embodiments are hereinafter described in detail with reference to accompanying drawings so as to make the attributes and merits more apparent to those skilled in the art. Among the accompanying drawings:

FIG. 1 is a flowchart illustrating a method in accordance with an embodiment;

FIG. 2 is a schematic diagram illustrating a structure of a system in accordance with an embodiment;

FIG. 3 is a flowchart illustrating a method in accordance with Preferred Embodiment 1;

FIG. 4 is a schematic diagram illustrating a structure of a system in Preferred Embodiment 1;

FIG. 5 is a flowchart illustrating a method in accordance with Preferred Embodiment 2;

FIG. 6 is a schematic diagram illustrating a structure of a system in Preferred Embodiment 2.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

To attain the major objective of embodiments, a method includes: downloading a raw advertisement creative file needed for publishing an advertisement, updating an advertisement target file according to the downloaded raw advertisement creative file and displaying the advertisement to be published according to the updated advertisement target file.

In this disclosure, an entity that publishes an advertisement is called “publisher”, i.e. an advertisement service apparatus to be described in embodiments hereafter; and an entity that displays an advertisement is called “display party”, i.e. a game client to be described in embodiments hereafter. The publisher may be any entity that is able to publish an advertisement and the display party may be any entity that is able to display an advertisement.

According to the embodiments, because the raw advertisement creative file needed for publishing an advertisement is downloaded from the advertisement service apparatus, a new advertisement can be published without updating the version of an online game on a client.

The advertisement target file in the above description includes a file that can be adopted by a game client to display an advertisement. The file may be used to display a game element in the game, such as the scenery or tool. The advertisement published through such file transmits marketing information without affecting the game experience of a user. For example, the files corresponding to game tables, cards and chessmen in online chess and card games, as well as the files of graphics displayed on roadside buildings in racing games can be adopted as the advertisement target files.

FIG. 1 is a flowchart illustrating a method in accordance with an embodiment. As shown in FIG. 1, the method is described as follows:

in Block 101, a raw advertisement creative file needed for publishing an advertisement is downloaded from an advertisement service apparatus; in Block 102, an advertisement target file in a game client is updated according to the downloaded raw advertisement creative file; and in Block 103, the published advertisement is displayed on the game client according to the updated advertisement target file.

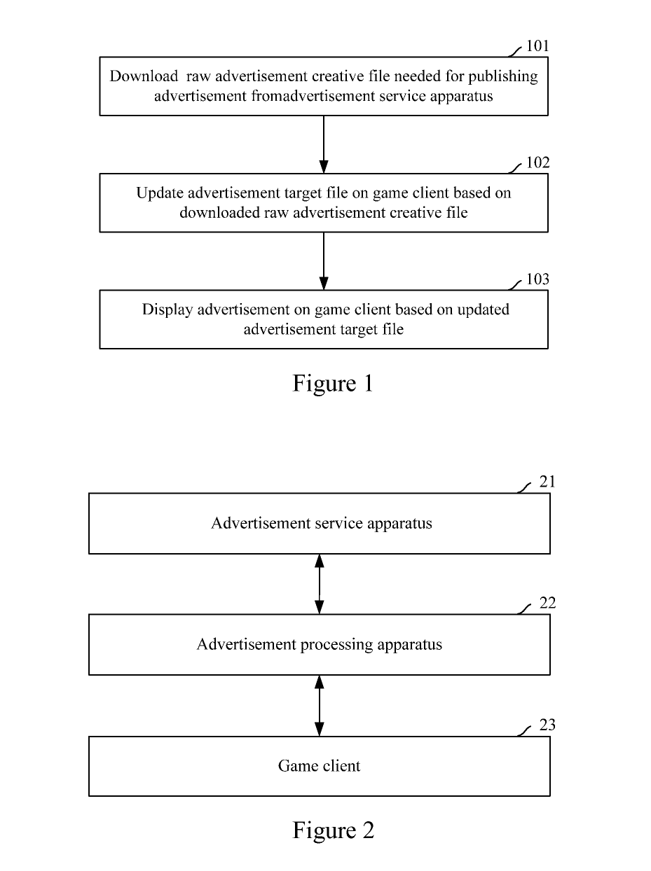

FIG. 2 is a schematic diagram illustrating a structure of a system in accordance with an embodiment. As shown in FIG. 2, the system includes: advertisement service apparatus 21, advertisement processing apparatus 22 and game client 23. The advertisement service apparatus 21 is mainly adapted to provide a raw advertisement creative file needed for publishing an advertisement. The advertisement processing apparatus 22 is mainly adapted to download the raw advertisement creative file from the advertisement service apparatus 21 and update an advertisement target file in the game client 23 according to the raw advertisement creative file; and the game client 23 is mainly adapted to display the published advertisement according to the updated advertisement target file.

The present disclosure is further described in detail hereinafter with reference to the accompanying drawings and embodiments so that the objective, solution and merits thereof could be more apparent.

In an embodiment, in order to achieve better advertisement effect and avoid wasting network resources, the status of the game client is considered before downloading a raw advertisement creative file so as to determine whether to download the raw advertisement creative file, or to determine the raw advertisement creative file that matches the game client for download. Preferred embodiments are described below according to the above two determination manners respectively.

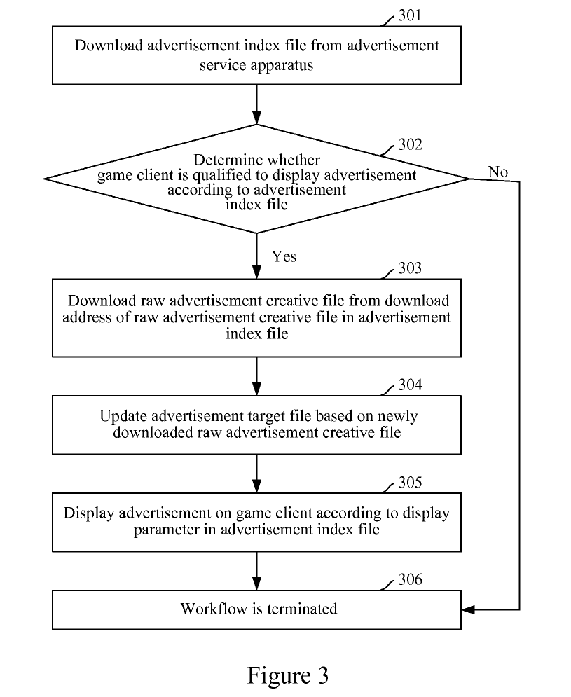

FIG. 3 is a flowchart illustrating a method in accordance with Preferred Embodiment 1. In Preferred Embodiment 1, before a raw advertisement creative file is downloaded, an advertisement index file containing a download address and an advertisement application parameter of the raw advertisement creative file is downloaded first, and whether to download the raw advertisement creative file is determined according to the advertisement application parameters contained in the advertisement index file. As shown in FIG. 3, the method is described as follows:

In Block 301, an advertisement index file is downloaded from the advertisement service apparatus. The advertisement index file contains the download address and the advertisement application parameter of the raw advertisement creative file, as well as other parameters such as advertisement target file information and a display parameter.

If the advertisement index file contains the advertisement target file information and/or display parameter, it indicates that the advertisement service apparatus determines the advertisement target file to be updated and the display parameter. The advertisement target file information indicates the advertisement target file to be updated and the advertisement target file information may be: a file name. The display parameter indicates the display mode of a current advertisement and the display parameter may include: starting time and/or ending time of the advertisement.

Obviously, the advertisement service apparatus may not provide the advertisement target file information and/or the display parameter. In this case, the advertisement target file to be updated and the display parameter can be determined according to the default advertisement target file and the default display parameter. The advertisement index file may be in the following format:

<AdResource>
...
<FileUrl>URL of the raw advertisement creative file to be
downloaded

</FileUrl>

</AdResource>
<Management>
...
<TimeStart>Starting time of the advertisement </TimeStart>
//in the

format of YYYY-MM-DD hh:mm:ss

<TimeEnd>Ending time of the advertisement</TimeEnd>//in the
format of

YYYY-MM-DD hh:mm:ss

</Management>
<Targeting>
...
<Age>Age, in the format of: 18-25</Age>
</Targeting>

In the file format given above, the text between <AdResource> and </AdResource> defines the download address information of the raw advertisement creative file; the text between <Management> and </Management> defines the display parameter of the advertisement, mainly including the starting time and the ending time of the advertisement here; and the text between <Targeting> and <Targeting> defines the advertisement application parameter, mainly including the user application parameter herein. More information can be defined in corresponding parts in the above format according to demands.

In the embodiments, the parameters in the advertisement index file other than the download address of the raw advertisement creative file are generally called advertisement management parameters. Obviously, besides the parameters described above, the advertisement management parameters may also include other parameters adapted to manage the advertisement.

In the workflow of this embodiment, the advertisement service apparatus determines the advertisement management parameters. The advertisement service apparatus may determine the advertisement target file information and the display parameter according to the content of the advertisement to be published. The display parameter may include: starting time and/or ending time of the advertisement.

In addition, in this Block, the advertisement index file can be downloaded from the preset address of the advertisement service apparatus when the user logs on the online game and/or be downloaded regularly during the displaying of the online game. The advertisement index file is the file corresponding to the advertisement to be published by the advertisement service apparatus.

In Block 302, whether to download the raw advertisement creative file is determined according to the advertisement application parameter in the advertisement index file, i.e. whether the game client is qualified to display the advertisement is determined. If the game client is qualified, Block 303 is performed; otherwise, Block 306 is performed.

The advertisement application parameter may include a user application parameter and/or a game application parameter. The user application parameter is adapted to describe the target population of the advertisement. For example, the user application parameter may indicate that the user of the game client should be 18 to 30 years old. In this case, whether to download the advertisement index file is determined according to the user register information provided when the user logs on the online game, i.e. whether the age of the user is between 18 and 30 is determined. If the age of the user is between 18 and 30, the game client is qualified to display the advertisement and the raw advertisement creative file can be downloaded; otherwise, the game client is not qualified to display the advertisement and the raw advertisement creative file is not downloaded.

In addition, the game application parameter is adapted to describe the type of the game targeted by the advertisement, such as chess and card game, sport game, and pet game. If the game in the game client is not of the type described by the game application parameter, the game client is not qualified to display the advertisement and the corresponding raw advertisement creative file is not downloaded. If the game in the game client is of the type described by the game application parameter, the game client is qualified to display the advertisement and the corresponding raw advertisement creative file is downloaded.

By using the above two management methods, the advertisement can be displayed to a group of specific people or in games of a specific type, i.e. the advertisement can be published to a specific targeted audience.

In Block 303, the raw advertisement creative file is downloaded from the download address of the raw advertisement creative file in the advertisement index file.

Because the size of the raw advertisement creative file is usually large, the bandwidth of the game client in use can be detected regularly so that the raw advertisement creative file is downloaded over idle bandwidth of the game client, and thus the game experience of the user is not affected.

In Block 304, the advertisement target file is updated by using the downloaded raw advertisement creative file according to the advertisement target file information in the advertisement index file.

As described in Block 301 of this preferred embodiment, if the advertisement index file does not contain the advertisement target file information, a default file, i.e. a fixed advertisement target file, may be updated. Or, the advertisement target file corresponding to the type of the raw advertisement creative file may be updated according to the type of the raw advertisement creative file, e.g. according to the format of the raw advertisement creative file, and when the file is a graphic file, the advertisement target file to be updated can also be determined according to the pixels of the graphic file.

In the above description of the manners for updating an advertisement target file, the advertisement target file to be updated may be a file originally adapted to display an advertisement in the game client, or a file originally adapted to display no advertisement in the game client. For example, in a card game, only the game table is originally adapted to display an advertisement; however, by applying the solution, the advertisement displayed on the game table can be updated, or the cards can be adapted to display an advertisement while the advertisement displayed on the game table is kept unchanged. It can be seen from the above description that the location of the advertisement in the game interface is determined after the advertisement target file to be updated is determined, and therefore, the advertisement service apparatus may determine the location of the advertisement in the game interface first and then determine the advertisement target file according to the determined location.

In addition, different update manners are adopted for updating the advertisement target file according to different display modes of the advertisement. For example, the display modes of the advertisement may relate to time, i.e. the starting and ending time of the advertisement, the appointed time of displaying the advertisement and the frequency of displaying the advertisement to one user. In this case, the manner for updating the advertisement target file may include: changing direction of a pointer from the original advertisement target file to the newly downloaded raw advertisement creative file and keeping the original advertisement target file. By such manner, the original file can be displayed when the advertisement need not be displayed, e.g. upon the ending time of the advertisement. When the original advertisement target file is of no use, i.e. would not be used in follow-up processes, another update manner can be adopted, i.e. the update manner that the original advertisement target file is overwritten by the newly downloaded raw advertisement creative file. As can be seen from the above description of the manners for updating the advertisement target file, the manner for updating the advertisement target file is sometimes determined according to the display mode of the advertisement.

In Block 305, the advertisement to be published currently is displayed by the game client according to the display parameter in the advertisement index file, and in Block 306, the workflow is terminated.

The display parameter may include: starting time and/or ending time of the advertisement.

In this preferred embodiment, Block 302 may be omitted and it is determined before Block 305, i.e. before displaying the advertisement to be published, whether the game client is qualified to display the advertisement according to the advertisement application parameter in the advertisement index file. If the game client is qualified, Block 305 is performed; otherwise, the workflow is terminated. The conditions for determining whether the game client is qualified to display the advertisement are described in Block 302.

According to the solution, the game client may regularly report to the advertisement service apparatus the advertisement statistics, e.g. the impression statistics of the advertisement, i.e. the number of times for displaying the advertisement in the game, so that the advertisement service apparatus may calculate the overall statistics of the advertisement publication information.

The foregoing describes the flowchart of the method adopted in Preferred Embodiment 1, and the following describes the system for publishing an online advertisement compatible with the method adopted in Preferred Embodiment 1.

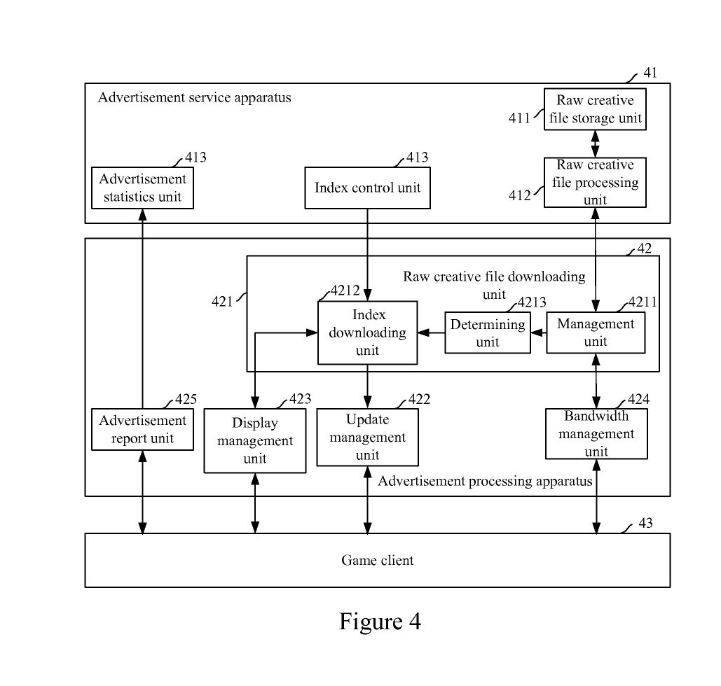

FIG. 4 is a schematic diagram illustrating a structure of a system in Preferred Embodiment 1. As shown in FIG. 4, the system includes: advertisement service apparatus 41, advertisement processing apparatus 42 and game client 43.

The advertisement processing apparatus 42 mainly includes: raw creative file downloading unit 421 and update management unit 422. The raw creative file downloading unit 421 is adapted to download a raw advertisement creative file from the advertisement service apparatus 41. The update management unit 422 is adapted to update, according to the raw advertisement creative file downloaded by the raw creative file downloading unit 421, an advertisement target file in the game client 43 connected to the update management unit 422. The raw creative file downloading unit 421 may further include index downloading unit 4212 and management unit 4211. The index downloading unit 4212 is mainly adapted to acquire an advertisement index file containing the download address of the raw advertisement creative file. The management unit 4211 is mainly adapted to download the raw advertisement creative file from the download address of the raw advertisement creative file in the advertisement index file acquired by the index downloading unit 4212. The raw advertisement creative file and the advertisement index file can be downloaded from the advertisement service apparatus 41 through the Hypertext Transfer Protocol (HTTP) over the Internet.

In addition, in order to avoid downloading raw advertisement creative files incompatible with game client 43 and wasting network resources, the raw creative file downloading unit 421 may further include determining unit 4213. The determining unit 4213 is adapted to determine, according to the advertisement application parameter contained in the advertisement index file, whether the game client 43 connected to the determining unit 4213 is qualified to display the advertisement. The determining unit 4213 is further adapted to instruct the management unit 4211 to download the raw advertisement creative file if the game client 43 is qualified.

Meanwhile, in order to publish the advertisement flexibly, the advertisement processing apparatus 42 may further include display management unit 423 if the advertisement index file further contains the display parameter. The display management unit 423 is mainly adapted to manage the displaying of the advertisement on the game client 43 according to the display parameter contained in the advertisement index file. If the advertisement index file does not contain the display parameter, the game client 43 displays the updated advertisement target file according to its original display mode of the advertisement target file.

The advertisement processing apparatus 42 may further include bandwidth management unit 424 so as not to affect the normal operation of the game while downloading the raw advertisement creative file. The bandwidth management unit 424 is mainly adapted to detect the bandwidth used by the game client 43, and manage the raw creative file downloading unit 421, according to a detection result, to download the raw advertisement creative file with the idle bandwidth of the game client 43.

The advertisement processing apparatus 42 may further include advertisement report unit 425 so that the advertisement service apparatus 41 may learn the advertisement publication status on the game client 43. The advertisement report unit 425 is mainly adapted to detect the advertisement publication status on the game client 43 and report the statistics of the advertisement to the advertisement service apparatus 41. If the display management unit 423 manages the displaying of the advertisement, the advertisement report unit 425 may further be connected to the display management unit 423 and acquire the statistics of the advertisement according to the management of the display management unit 423 on the advertisement.

The advertisement processing apparatus 42 may be an apparatus connected to the game client 43, or be integrated in the game client 43.

As shown in FIG. 4, the advertisement service apparatus 41 includes raw creative file storage unit 411 and raw creative file processing unit 412. The raw creative file storage unit 411 is mainly adapted to store raw advertisement creative files needed for publishing advertisements and the raw creative file processing unit 412 is adapted to extract a raw advertisement creative file from the raw creative file storage unit 411 and send the raw advertisement creative file to the advertisement processing apparatus 42.

The advertisement service apparatus 41 may further include index management unit 413. The index management unit 413 is mainly adapted to send an advertisement index file containing the download address of the raw advertisement creative file to the advertisement processing apparatus 42.

The advertisement service apparatus 41 may further include advertisement statistics unit 414 so as to learn the publication status of the advertisement on the game client 43. The advertisement statistics unit 414 is connected to the advertisement report unit 425 in the advertisement processing apparatus 42 and is adapted mainly to process the statistics reported by the advertisement processing apparatus 42. The data transmission between the advertisement statistics unit 414 and the advertisement report unit 425 can use the TCP/IP private protocol.

In the advertisement service apparatus 41, the raw creative file storage unit 411, the raw creative file processing unit 412 and the index management unit 413 can be configured in one network entity or in different network entities according to practical situations.

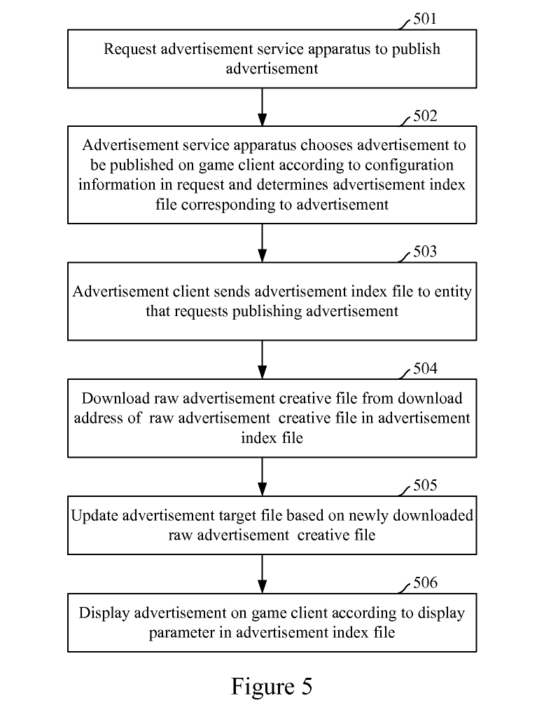

FIG. 5 is a flowchart illustrating a method in accordance with Preferred Embodiment 2. In this preferred embodiment, the advertisement service apparatus chooses a raw advertisement creative file compatible with the game client so that the advertisement service apparatus can publish an advertisement to a specific target and improve the advertisement effect.

In Block 501, a request for publishing an advertisement is sent to the advertisement service apparatus, the request containing the configuration information of the game client.

The configuration information may include: the game type corresponding to the game client and/or the user information of the user using the game client currently. The request can be sent to an appropriate advertisement service apparatus according to the preset address of the advertisement service apparatus.

In Block 502, the advertisement service apparatus chooses an advertisement to be published on the game client according to the configuration information in the request and determines the advertisement index file corresponding to the advertisement.

If the configuration information includes the user information, e.g. the age of the user is 25 and gender of the user is male, an advertisement suitable for the user can be chosen to be published. If the configuration information includes game type, e.g. chess and card game, an advertisement suitable for publishing in chess and card games can be chosen. Obviously, the configuration information may include other information and the advertisement service apparatus may choose suitable advertisement for the game client according to any combination of varieties of information. The advertisement service apparatus may also set advertisement application parameters for every advertisement, and choose the advertisement to be published on the game client by matching the configuration information of the game client with the advertisement application parameters.

In Block 503, the advertisement service apparatus sends the advertisement index file to the request party requesting publishing the advertisement.

The contents of the advertisement index file can be similar to those described in Block 301 of Preferred Embodiment 1.

Blocks 504-506 are similar to Blocks 303-305 of Preferred Embodiment 1 and will not be described further herein.

The foregoing describes the flowchart of the method adopted in Preferred Embodiment 2, and the following describes the system for publishing an online advertisement compatible with the method adopted in Preferred Embodiment 2.

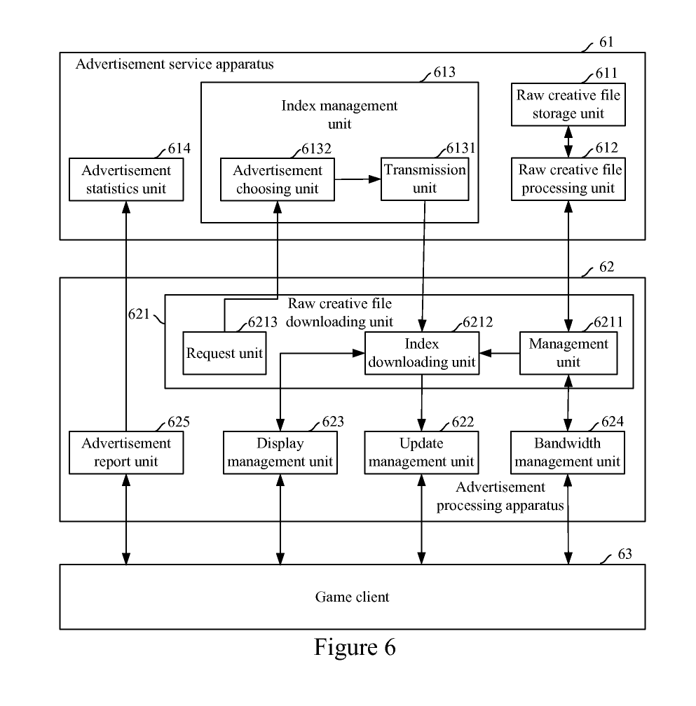

FIG. 6 is a schematic diagram illustrating a structure of a system in Preferred Embodiment 2. As shown in FIG. 6, the system includes: advertisement service apparatus 61, advertisement processing apparatus 62 and game client 63.

The advertisement processing apparatus 62 includes raw creative file downloading unit 621 and update management unit 622. The raw creative file downloading unit 621 further includes index downloading unit 6212 and management unit 6211, which have similar functions to corresponding units respectively in the advertisement processing apparatus 42 in Preferred Embodiment 1 and will not be described further herein.

Unlike the corresponding unit in Preferred Embodiment 1, the raw creative file downloading unit 621 in FIG. 6 does not include the determining unit 4213, but a request unit 6213 instead. The request unit 6213 is adapted mainly to request the advertisement service apparatus 61 to publish an advertisement.

The advertisement processing apparatus 62 further includes: display management unit 623, bandwidth management unit 624 and advertisement report unit 625, which are similar to corresponding units in Preferred Embodiment 1 and will not be described further herein.

The advertisement service apparatus 61 in FIG. 6 chooses the advertisement to be published according to the configuration information reported by the advertisement processing apparatus 62, and the different between this preferred embodiment and Preferred Embodiment 1 is that the index management unit 613 further includes advertisement choosing unit 6132 and transmission unit 6131. The advertisement choosing unit 6132 is mainly adapted to receive the request for publishing an advertisement and choose the advertisement to be published on the game client according to the configuration information of the game client contained in the request; and is further adapted to determine the advertisement index file corresponding to the chosen advertisement. The transmission unit 6131 is mainly adapted to send the advertisement index file determined by the advertisement choosing unit 6132. Other components of the system in Preferred Embodiment 2 are similar to corresponding components in Preferred Embodiment 1 and will not be described further herein.

The solution can be applied to the game clients running online games as well as the game clients running offline games. The advertisement processing apparatus is not necessarily configured in a game client, and therefore, even if the game client does not access the Internet, the solution can be applied as long as the advertisement processing apparatus has an access to the Internet.

According to the preferred embodiments, the solution of the embodiments can publish a new advertisement without updating the version of an online game on the client. The solution enables dynamic advertisement publication in online games without updating the version of online games. Furthermore, an advertisement index file can be adopted in the solution of the embodiments to contain advertisement management parameters adapted to manage the advertisements displayed in online games, and the advertisement publication can therefore be more flexible and the advertisements can be more effective.

The foregoing is only preferred embodiments and is not for use in limiting the disclosure. Any modification, equivalent replacement or improvement made without departing from the spirit and principles should be covered by the protection scope.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for publishing an online advertisement, comprising:
downloading a raw advertisement creative file needed for publishing an advertisement;
updating an advertisement target file according to the raw advertisement creative file; and
displaying the advertisement according to the updated advertisement target file.

2. The method according to claim 1, further comprising:
acquiring an advertisement index file containing a download address of the raw advertisement creative file before downloading the raw advertisement creative file needed for publishing the advertisement;
wherein downloading the raw advertisement creative file comprises:
downloading the raw advertisement creative file from the download address contained in the advertisement index file.

3. The method according to claim 2, wherein the advertisement index file further comprises an advertisement application parameter; and
the method further comprises:
determining, according to the advertisement application parameter, whether an entity to display the advertisement is qualified to display the advertisement, and downloading the raw advertisement creative file if the entity is qualified.

4. The method according to claim 3, wherein the advertisement application parameter comprises at least one of a user application parameter and a game application parameter.

5. The method according to claim 2, wherein acquiring the advertisement index file containing the download address of the raw advertisement creative file comprises:
sending a request for publishing the advertisement to an entity that publishes the advertisement; and
receiving the advertisement index file containing the download address of the raw advertisement creative file from the entity that publishes the advertisement.

6. The method according to claim 5, wherein the request comprises:
configuration information of an entity that displays the advertisement; and
receiving the advertisement index file comprises:
receiving the advertisement index file corresponding to the advertisement that is chosen by the entity that publishes the advertisement according to the configuration information.

7. The method according to claim 6, wherein the entity that displays the advertisement is a game client and the configuration information comprises: information of a game corresponding to the game client, and/or information of a user using the game client.

8. The method according to claim 2, wherein the advertisement index file further comprises a display parameter;
displaying the advertisement according to the updated advertisement target file comprises:
displaying the advertisement according to the updated advertisement target file and the display parameter.

9. The method according to claim 2, wherein the advertisement index file further comprises advertisement target file information; and
updating the advertisement target file comprises:
updating the advertisement target file corresponding to the advertisement target file information in the advertisement index file.

10. A system for publishing an online advertisement, comprising:
an advertisement service apparatus, adapted to provide a raw advertisement creative file needed for publishing an advertisement;
an advertisement processing apparatus, adapted to download the raw advertisement creative file from the advertisement service apparatus and update an advertisement target file according to the raw advertisement creative file; and
a game client, adapted to display the advertisement according to the updated advertisement target file in the game client.

11. An advertisement processing apparatus, comprising:
a raw creative file downloading unit, adapted to download a raw advertisement creative file from an advertisement service apparatus; and
an update management unit, adapted to update, according to the raw advertisement creative file, an advertisement target file in a game client connected to the update management unit.

12. The apparatus according to claim 11, wherein the raw creative file downloading unit comprises:
an index downloading unit, adapted to acquire an advertisement index file containing a download address of the raw advertisement creative file, and
a management unit, adapted to download the raw advertisement creative file from the download address of the raw advertisement creative file in the advertisement index file.

13. The apparatus according to claim 12, wherein the raw creative file downloading unit further comprises:
a determining unit, adapted to determine, according to an advertisement application parameter contained in the advertisement index file, whether the game client connected to the advertisement processing apparatus is qualified to display the advertisement; and instruct the management unit to download the raw advertisement creative file if the game client is qualified.

14. The apparatus according to claim 12, wherein the raw creative file downloading unit further comprises:
a request unit, adapted to request the advertisement service apparatus to publish the advertisement.

15. The apparatus according to claim 12, further comprising one of:
a display management unit, adapted to manage displaying of the advertisement on the game client according to a display parameter contained in the advertisement index file acquired by the index downloading unit;
a bandwidth management unit, adapted to detect bandwidth used by the game client, and manage the raw creative file downloading unit, according to a detection result, to download the raw advertisement creative file with idle bandwidth of the game client; and
an advertisement report unit, adapted to detect an advertisement publication status on the game client, and report statistics of the advertisement to the advertisement service apparatus.

16. An advertisement service apparatus, comprising:
a raw creative file storage unit, adapted to store a raw advertisement creative file needed for publishing an advertisement; and
a raw creative file processing unit, adapted to extract the raw advertisement creative file from the raw creative file storage unit and send the raw advertisement creative file to an advertisement processing apparatus.

17. The apparatus according to claim 16, further comprising:
an index management unit, adapted to send an advertisement index file containing a download address of the raw advertisement creative file to the advertisement processing apparatus.

18. The apparatus according to claim 17, wherein the index management unit comprises:
an advertisement choosing unit, adapted to receive a request for publishing the advertisement and choose the advertisement to be published according to configuration information of a game client contained in the request, and determine the advertisement index file corresponding to the chosen advertisement; and
a transmission unit, adapted to send the advertisement index file determined by the advertisement choosing unit.

19. The apparatus according to claim 16, further comprising:
an advertisement statistics unit, adapted to learn a publication status of the advertisement on a game client.
